(19) United States
(12) Patent Application Publication
(10) Pub. No.: US 2003/0124165 A1
(43) Pub. Date: Jul. 3, 2003

(54) Insect repellent composition comprising tarchonanthus comphoratus and repellency enhancer

(76) Inventors: Juergen Herbert Vollhardt, Lincoln Park, NJ (US); Ravikumar T. Pillai, Westwood, NJ (US)

Correspondence Address: PENDORF & CUTLIFF, 3940 Venetian Way, Tampa, FL, 33634, US

(21) Appl. No.: 10/036,220

(22) Filed: Dec. 24, 2001

(51) Int. Cl. A01N 25/32

(52) U.S. Cl. 424/406

(57) ABSTRACT

Insect repellent compositions more efficient than those comprising Tarchonanthus camphoratus (or fractions of such extracts) alone, the insect repellant compositions of the invention comprising an extract of Tarchonanthus camphoratus (or fractions of such extracts), and a natural or synthetic triglyceride, wherein the total amount of said extract and said triglyceride is an insect repellent active amount. Also disclosed is a method for synergistically enhancing the insect repellent activity of an extract of Tarchonanthus camphorates, and a method for repelling insects.

### BACKGROUND OF THE INVENTION

1. Field of the Invention

The present invention relates to insect repellent compositions comprising an extract of Tarchonanthus camphoratus (or fractions of such extracts). Tarchonanthus camphoratus, also known as wild camphor tree, camphor bush, sage wood, wild cotton, wild sage wood or African flee bain grows into a shrub of usually 2-3 m in height. Pieces of wood or twigs from Tarchonanthus camphoratus as well as extracts thereof are known as insect repellents for a considerable while, see John Mitchell Watt and Maria Gerdina Breyer-Brandwijk, The Medicinal and Poisonous Plants of Southern and Eastern Africa, E. & S. Livingstone Ltd., Edinburgh and London, 1962, page 219-220, see also U.S. Pat. No. 5,607,674 in the name of Rovesti et al.

The present invention concerns extracts of Tarchonanthus camphoratus, and it is to be noted that said extracts can be obtained by a number of extraction methods. Examples of such extraction methods are steam distillation, maceration, cold pressing, solvent extraction (using e.g. hydrocarbons, alcohols or carbon dioxide in the liquid or supercritical state as the solvent).

All of these extracts can be used for the purposes of the present invention, and likewise fractions of said extracts can be used for the purposes of the present invention.

The source for the extract of Tarchonanthus camphoratus (or a fraction thereof) generally is the leaves (fresh or dried) or their derivatives, although extracts of the wood or the bark of Tarchonanthus camphoratus are also useful.

Extracts of Tarchonanthus camphoratus leaves generally contain the following ingredients: Alpha-Pinene, Camphene, Beta-Pinene, Delta-2-Carene, Alpha-Phellandrene, Limonene, Gamma-Terpinene, Terpinolene, 1,8-Cineole, Fenchol, 1-Terpinen-4-ol, Alpha-Terpineol, Fenchone, Trans-Caryiophyllene, Bergamotene, Delta-Cadinene, and Alpha-Curcumene.

The insect repellent compositions of the present invention can contain fractions of an extract of Tarchonanthus camphoratus as long as the fraction comprises enough of the insect repellent material originally contained in the extract.

Although it was possible to obtain effective insect repellents by using an extract of Tarchonanthus camphoratus in a pharmaceutically acceptable carrier there is still a strong need for even more efficient insect repellents.

Furthermore, as Tarchonanthus camphoratus extract is quite expensive, there is a need for insect repellent formulations which comprise a reduced amount of Tarchonanthus camphoratus extract, but still have the same insect repellent activity as known insect repellent formulations comprising Tarchonanthus camphoratus extract.

### SUMMARY OF THE INVENTION

It is therefore a first objective of the present invention to provide improved insect repellent compositions comprising an extract of Tarchonanthus camphoratus or an insect repellent fraction thereof exhibiting an improved insect repellent activity.

It is a further objective of the present invention to provide a method for enhancing the insect repellent activity of an extract of Tarchonanthus camphoratus or an insect repellent fraction thereof.

And finally, it is as an objective of the present invention to provide a method for repelling insects, in which an insect repellent composition is used which comprises Tarchonanthus camphoratus extract (or a fraction thereof), and in which the insect repellency is higher than with the use of Tarchonanthus camphoratus alone.

### DETAILED DESCRIPTION OF THE INVENTION

The present invention meets the above first objective by providing an insect repellent composition, comprising

an extract of Tarchonanthus camphoratus or an insect repellent fraction thereof, and

a natural or synthetic triglyceride,

wherein the total amount of said extract and said triglyceride is an insect repellent active amount.

Herein, the term “triglyceride” means (a) a pure triglyceride or (b) a mixture of two or more different triglycerides (e.g. as found in naturally occurring oils like corn oil).

Favourably, the natural or synthetic triglyceride is (a) such chosen and (b) provided in a sufficient amount that it synergistically (and with a statistical significance, p-value <0.05) enhances the insect repellent activity (repellency) of said extract of Tarchonanthus camphoratus or the insect repellent fraction thereof.

Correspondingly, the second objective is met by providing a method for synergistically enhancing the insect repellent activity of an extract of Tarchonanthus camphoratus or an insect repellent fraction thereof, comprising adding a (statistically significant, p-value <0.05) insect repellent activity synergistically enhancing amount of a natural or synthetic triglyceride to the extract of Tarchonanthus camphoratus or the insect repellent fraction thereof.

Herein, a synergistically enhancing amount of a natural or synthetic triglyceride is to be understood an amount which, when added to the extract of Tarchonanthus camphoratus or the insect repellent fraction thereof, leads to an insect repellent activity (repellency) of the resulting mixture which is higher than the insect repellent activity of each individual component (a) natural or synthetic triglyceride and (b) extract of Tarchonanthus camphoratus or insect repellent fraction thereof, as can be shown by tests according to the recommendations of the American Society for Testing and Materials, form E-939-83, “Standard method of field testing topical applications of compounds as repellents for medically important and pest athropods (including insects, ticks and mites)” using mosquitoes of the type Aedes aegypti.

Furthermore, the third objective is met by providing a method for repelling insects comprising topically applying a composition comprising an extract of Tarchonanthus camphoratus or an insect repellent fraction thereof, and a natural or synthetic triglyceride.

Favourably, said total amount of said extract and said triglyceride in the insect repellent composition according to the present invention provides a mean bite reduction of at least 80% (preferably at least 95%) on a statistically significant basis with a p-value <0.05 in a test according to the recommendations of the American Society for Testing and Materials, form E-939-83, “Standard method of field testing topical applications of compounds as repellents for medically important and pest athropods (including insects, ticks and mites)” using mosquitoes of the type Aedes aegypti, and using food grade corn oil as control.

The present invention is based on the surprising discovery that the insect repellent activity of Tarchonanthus camphoratus extract can be drastically (synergistically) enhanced by adding to said extract (or fraction thereof) a natural or synthetic triglyceride. The use of naturally occurring triglycerides is preferred, i.e. the use of naturally occurring fats and fatty oils. (Food grade) Corn oil is in particular preferred.

Depending on the particular needs the triglyceride used in addition to Tarchonanthus camphoratus extract (or a fraction thereof) is chosen to possess an own insect repellent activity or not.

While the additive use of cheap non-active triglycerides like (preferably food grade) corn oil is sufficient for reaching very high repellency levels (=high bite reductions in the typical tests carried out for assessing repellency), the insect repellencies obtained by combining Tarchonanthus camphoratus extract (or a fraction thereof) and a natural or synthetic triglyceride which even in the absence of Tarchonanthus camphoratus extract (or a fraction thereof) exhibits an insect repellent activity, e.g. emu oil, are even higher. In each case, the repellency increase observed upon combining Tarchonanthus camphoratus with a triglyceride cannot be attributed to a mere additive effect. To the contrary, the observed effects are clearly synergistic. With respect to emu oil reference is made to US 2001/0010813 A1 in which a general teaching is given that compositions comprising ratite oil (note: emus are ratites), an active fraction therof or a mixture of fatty acids and at least one other insect repellent were found to exhibit synergistic results. However, (a) the combinations tested according to US 2001/0010813 A1 do not comprise Tarchonanthus camphoratus extract (or a corresponding fraction thereof), and (b) the synergism observed according to the present invention when emu oil and Tarchonanthus camphoratus extract (or a corresponding fraction thereof) are combined is surprisingly pronounced.

Furthermore, the US 2001/0010813 A1 does not teach the combination of Tarchonanthus camphoratus extract (or a fraction thereof) and a natural or synthetic triglyceride which even in the absence of Tarchonanthus camphoratus extract (or a fraction thereof) exhibits an insect repellent activity, but which is not ratite oil or an active fraction therof or a mixture of all the fatty acids found in ratite oil (i.e. a mixture of myristic, arachidonic, palmitic, stearic, linolenic, palmitoleic, oleic, and linoleic acid). The triglycerides which according to US 2001/0010813 A1 exhibit a synergistic effect when used with other insect repellents are not present in certain preferred compositions and formulations according to the present invention.

Favourably, the weight ratio of Tarchonanthus camphoratus extract (or a corresponding fraction) to natural or synthetic triglyceride is in the range of 1:1 to 1:1000. When Tarchonanthus camphoratus extract (or a fraction thereof) is combined with a triglyceride which itself exhibits an insect repellent activity, the weight ratio preferably is in the range of between 1:5 and 1:1000.

By adjusting the ratio of ingredients within an insect repellent composition according to the present invention it is possible to adjust the insect repellent activity to a percentage of bite reduction of at least 80%, preferably 95%, in a test based on the recommendations of the American Society for Testing Materials, Form E-938-83, using mosquitoes of the type Aedes aegypti, and using food grade corn oil as control.

Typically, an insect repellent composition of the present invention further comprises a cosmetic and/or pharmaceutically acceptable carrier as used in the art. Optionally, the composition further comprises one or more typical additives In preferred cosmetic and/or pharmaceutical formulations according to the invention the total amount of said extract of Tarchonanthus camphoratus or an insect repellent fraction thereof, and the natural or synthetic triglyceride typically is in the range of from 5 to 100% by weight, preferably 10 to 20% by weight, with respect to the total weight of the formulation. Again, the natural or synthetic triglyceride is favourably (a) such chosen and (b) provided in a sufficient amount that it synergistically (and with a statistical significance, p-value <0.05) enhances the insect repellent activity (repellency) of said extract of Tarchonanthus camphoratus or the insect repellent fraction thereof.

Particularly preferred formulations according to the present invention are:

(a) skin oils or skin lotions, wherein the total amount of said extract of Tarchonanthus camphoratus or an insect repellent fraction thereof and said triglyceride is in the range of from 5 to 100% by weight, preferably 5 to 50% by weight, with respect to the total weight of the formulation,

(b) formulations which additionally comprise an effective amount of a sunsreen agent, and

(c) formulations which additionally comprise an effective amount of a film forming agent, in particular for topical application of a film of the formulation.

Preferred embodiments of the present invention are described in the following examples.

### EXAMPLES 1-3

### Insect Repellent Formulations

The following formulations have been prepared and showed an excellent insect repellency in tests (Examples 1-3).

### Example 1

Insect Repellent Gel

| Ingredients | Parts by weight |
|---|---|
| Sepigel 305 (Polyacrylamide and C13-14 | 4.00 |
| Isoparaffin and Laureth-7) | |
| Dragoxat EH (Ethylhexyl Ethylhexanoate) | 5.00 |
| Insect Repellent CL (mixture of corn oil and | 5.00 |
| leleshwa oil in a weight ratio of 99:1) | |
| Ganex V-220 (VP/Eicosene Copolmer) | 0.50 |
| Glycerin | 3.00 |
| Dragocide liquid (Phenoxyethanol, | 0.50 |
| Methylparaben, Ethylparaben, Butylparaben, | |
| Isobutylparaben and Propylparaben) | |
| Deionised Water | 82.00 |
| Total: | 100.00 |

### Example 2

Insect Repellent Spray Lotion

| Ingredients | Parts by weight |
|---|---|
| Permulen TR-2 (Acrylates/C10-30 Alkyl Acrylate | 0.15 |
| Crosspolymer) | |
| Carbopol ETD 2020 (Carbomer) | 0.10 |
| Propylene glycol | 3.00 |
| Oxynex K liquid (PEG-8 and Tocopherol and | 0.10 |
| Ascorbyl Palmitate and Ascorbic Acid and Citric | |
| Acid) | |
| AMP-95 (Aminomethyl Propanol) | 0.15 |
| Dragoxat EH (Ethylhexyl Ethylhexanoate) | 5.00 |
| IR Repellent SL (mixture of soybean oil and | 10.00 |
| leleshwa oil in a weight ratio of 99:1) | |
| Dragocide liquid (Phenoxyethanol, | 0.50 |
| Methylparaben, Ethylparaben, Butylparaben, | |
| Isobutylparaben and Propylparaben) | |
| Deionised water | 81.00 |
| Total | 100.00 |

### Example 3

Insect Repellent Lotion

| Ingredients | Parts by weight |
|---|---|
| Dragowax SE (Cetearyl alcohol and Ceteareth- | 8.00 |
| 18) | |
| Dragoxat EH (Ethylhexyl Ethylhexanoate) | 5.00 |
| Dow Corning 245 (Cyclomethicone) | 2.00 |
| Ganex V-220 (VP/Eicosense Copolymer) | 0.50 |
| Insect Repellent BL (mixture of borage oil and | 20.00 |
| leleshwa oil in a weight ratio of 99:1) | |
| Glycerin | 3.00 |
| Dragocide liquid (Phenoxyethanol, | 0.50 |
| Methylparaben, Ethylparaben, Butylparaben, | |
| Isobutylparaben and Propylparaben) | |
| Deionised water | 61.00 |
| Total | 100.00 |

### Example 4

Insect Repellent Test

Insect repellency test were done at Carroll-Loye Biological Research, California, USA. All tests were done with a very aggressive biting species of mosquito named Aedes aegypti. Food grade corn oil was used as control except otherwise noted. Test subjects were adult males and females and test materials were applied at a dosage of 1.5 g/600 cm² of skin surface area. The application method was according to the recommendation of the American Society for testing and Materials form E-939-83: “Standard method of field testing topical applications of compounds as repellents for medically important and pest athropods (including insects, ticks and mites)”.

Synergism in the Repellency of Leleshwa Oil (Extract of Tarchonanthus camphorates) with Food Grade Corn Oil

| Test material | Percentage bite reduction |
|---|---|
| 1% Leleshwa oil in Ethyl alcohol | 34 |
| 5% Leleshwa oil in Ethyl acohol | 40 |
| 1% Leleshwa oil in Corn oil | 99.1 |
| Ethyl alcohol | — |
| Corn oil | — |

The control corn oil and the (second) control ethyl alcohol gave 40/41 bites, respectively.

Percentage bite reduction was calculated relative to the corn oil control.

For each treatment, subject mean biting rates were calculated. Treatment mean biting rates were calculated as grand means of subject means. Mean bite rate reduction relative to the control was calculated. Percentage bite reduction value is based on mean bite rate reduction data.

What is claimed is:

1. Insect repellent composition, comprising:
an extract of Tarchonanthus camphoratus or an insect repellent fraction thereof, and
a natural or synthetic triglyceride,
wherein the total amount of said extract and said triglyceride is an insect repellent active amount.

2. Insect repellent composition according to claim 1,
wherein said triglyceride itself is not insect-repellent.

3. Insect repellent composition according to any of the preceding claims, wherein the insect repellent activity of the composition is adjusted, so that a statistically significant (p<0.05) mean bite reduction of at least 80% is provided in a test according to the recommendations of the American Society for Testing and Materials form E-939-83, using mosquitoes of the type Aedes aegypti, and using food grade corn oil as control.

4. Insect repellent composition according to any of the preceding claims, wherein the composition further comprises a cosmetical or pharmaceutically acceptable carrier.

5. A method for synergistically enhancing the insect repellent activity of an extract of Tarchonanthus camphoratus or an insect repellent fraction thereof, comprising:
adding an insect repellent activity synergistically enhancing amount of a natural or synthetic triglyceride to the extract of Tarchonanthus camphoratus or the insect repellent fraction thereof.

6. A method for repelling insects comprising:
topically applying a composition comprising
an extract of Tarchonanthus camphoratus or an insect repellent fraction thereof, and
a natural or synthetic triglyceride,
wherein the total amount of said extract and said triglyceride is an insect repellent active amount.

7. A method according to claim 6, wherein said total amount provides a statistically significant (p<0.05) mean bite reduction of at least 80% in a test according to the recommendations of the American Society for Testing and Materials form E-939-83, using mosquitoes of the type Aedes aegypti, and using food grade corn oil as control.

8. A method according to claim 6, wherein the composition further comprises a cosmetic and/or pharmaceutically acceptable carrier.

9. Cosmetic and/or pharmaceutical formulation, comprising
an extract of Tarchonanthus camphoratus or an insect repellent fraction thereof,
a natural or synthetic triglyceride,
a cosmetic and/or pharmaceutically acceptable carrier, and, optionally
one or more typical additives,
wherein the total amount of said extract and said triglyceride is an insect repellent active amount.

10. Cosmetic and/or pharmaceutical formulation according to claim 9, wherein the total amount of said extract and said triglyceride is in the range of from 5 to 100% by weight, preferably 10 to 20% by weight, with respect to the total weight of the formulation.

11. Formulation according to claim 9, wherein the formulation is a skin oil or skin lotion, and wherein the total amount of said extract and said triglyceride is in the range of from 5 to 100% by weight, preferably 5 to 50% by weight, with respect to the total weight of the formulation.

12. Formulation according to any of claims 9-11, wherein the formulation additionally comprises an effective amount of a sunsreen agent.

13. Formulation according to any of claims 9-12, wherein the formulation additionally comprises an effective amount of a film forming agent for topical application of a film of the formulation.
